(19) United States
(12) Patent Application Publication
(10) Pub. No.: US 2010/0154527 A1
(43) Pub. Date: Jun. 24, 2010

(54) Elevator Brake Condition Testing

(75) Inventor: Juan Antonio Illan, Madrid (ES)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Otis Elevator Company, Farmington, CT (US)

(21) Appl. No.: 12/223,838

(22) PCT Filed: Feb. 14, 2006
(86) PCT No.: PCT/US2006/005259

§ 371 Date: Aug. 11, 2008

(51) Int. Cl. G01L 5/28; B66B 1/32

(52) U.S. Cl. 73/121; 187/247

(57) ABSTRACT

A brake (42) is tested in an elevator system (10) including a car (12) and a counterweight (14) connected to the car (12) by a rope (16). The car (12) is positioned at a reference position in the hoistway (HW) adjacent to a hoistway limit switch (23), and the brake (42) is engaged to hold the car (12) at the reference position. The rotating member (46) is then driven to provide a testing force on the brake (42) that simulates a load in the elevator car (12) of at least a maximum rated load for the car (12). The brake test is terminated if the hoistway limit switch (23) is actuated.

### BACKGROUND OF THE INVENTION

The present invention relates to elevators and elevator systems. In particular, the present invention relates to testing the condition of an elevator brake system.

Elevator brake systems must be tested periodically to assure that the brake has sufficient braking capacity for safe elevator operation. In some elevator systems, such as those including a one or two speed motor drive, the brake is employed to decelerate or level the elevator speed, while the motor is employed only for acceleration of the elevator. In these systems, the braking capacity is readily determined, because the brake is used to actively control the elevator. For example, the braking capacity of the elevator brake system may be tested by verifying that the elevator decelerates or levels as expected when the brake is applied. The elevator brake system may also be tested by applying the brake and measuring the distance the elevator travels before coming to a stop.

Many current elevator systems employ a pulse width modulated drive signal to drive the elevator motor. In these systems, the normal deceleration and leveling of the elevator is performed by adjusting the frequency of the drive signal to provide the desired elevator motion. For example, to decelerate the elevator, the variable frequency drive may lower the pulse width modulation of the drive signal or employ dynamic or regenerative braking.

In elevator systems employing a pulse width modulated motor drive signal, the brake is typically only engaged in emergency situations and when the elevator is stopped to secure the elevator in place. Thus, the brake capacity is not easily verifiable through normal use, and wear of the brake linings, foreign particles in the brakes, and brake aging may cause the brake to fail to hold the elevator in place on a landing. One approach to testing the brakes in a variable frequency drive system involves loading the car with weights to simulate a full load and performing emergency stops with the brake. However, this test requires transporting the weights to every site to be tested, which is a very cumbersome process. In addition, the emergency stops put excessive strain on the brake, leading to an accelerated decline of the brake capacity.

### BRIEF SUMMARY OF THE INVENTION

The subject invention is directed to testing a brake in an elevator system including a car and a counterweight connected to the car by a rope. The rope is actuated by a rotating member that is driven by a motor. The car is positioned at a reference position in the hoistway adjacent to a hoistway limit switch, and the brake is engaged to hold the car at the reference position. The rotating member is then driven to provide a testing force on the brake that simulates a load in the elevator car of at least a maximum rated load for the car. The brake test is terminated if the hoistway limit switch is actuated.

### BRIEF DESCRIPTION OF THE DRAWINGS

FIG. 1 is a perspective view of an elevator system including an elevator car and a counterweight connected to the elevator car by a rope.

FIG. 2 is a front view of an elevator hoist machine for controlling movement of the elevator car and the counterweight

FIG. 3 is a flow diagram for a process of testing the elevator hoist machine brake according to the present invention.

### DETAILED DESCRIPTION

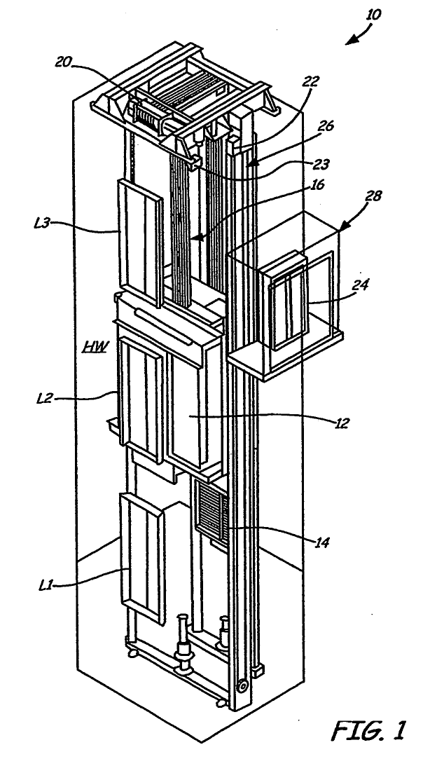

FIG. 1 is a perspective view of an elevator system 10 including elevator car 12, counterweight 14, ropes 16, elevator hoist machine 20, position encoder 22, limit switch 23, and controller 24. Elevator car 12 and counterweight 14 are connected with ropes 16 and suspended in hoistway HW including landings L1, L2, and L3.

Elevator car 12 and counterweight 14 are interconnected by ropes 16 to move concurrently and in opposite directions within hoistway HW. Counterweight 14 balances the load of elevator car 12 and facilitates movement of elevator car 12. In one embodiment, counterweight 14 has a mass approximately equal to the mass of elevator car 12 plus one half of the maximum rated load of elevator car 12. Ropes 16 may include steel cables or coated steel belts. Ropes 16 engage elevator hoist machine 20, which controls movement between elevator car 12 and counterweight 14.

Position encoder 22 is mounted on the upper sheave of elevator speed governor system 26. Position encoder 22 provides signals to controller 24 related to the position of elevator car 12 within hoistway HW.

Limit switch 23 is actuated by a cam (not shown) that rides with elevator car 12 to insure that elevator car 12 does not run into the overhead structure, which includes elevator hoist machine 20. Elevator 10 may include additional limit switches to prevent elevator car 12 from running into the top or bottom of hoistway HW. Limit switch 23 is actuated when elevator car 12 moves upwardly past top landing L3. Limit switch 23 may be a mechanically actuated lever or switch, or an electrical switch that is actuated when the cam comes into electrical contact with limit switch 23. When actuated by elevator car 12, limit switch 23 provides a signal to controller 24 to remove power to hoist motor 20, which prevents all further travel in either direction.

Controller 24, which is located in controller room 28 in hoistway HW, provides signals to elevator hoist machine 20 to control acceleration, deceleration, leveling, and stopping of elevator car 12. Controller 24 also receives signals from position encoder 22 and limit switch 23.

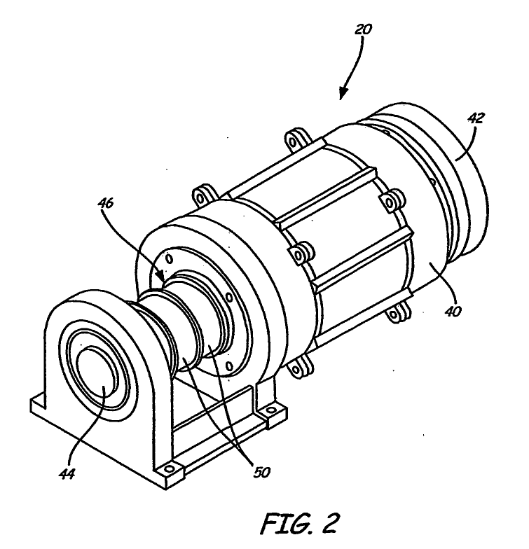

FIG. 2 is a detailed perspective view of elevator machine 20 for controlling movement of elevator car 12 and counterweight 14. Elevator machine 20 includes motor 40, brake 42, drive shaft 44, and sheave 46. Drive shaft 44 projects from motor 40, and sheave 46 is fixedly disposed on drive shaft 44. Brake 42 is adjacent to motor 40 at the opposite end of drive shaft 44 from sheave 46. Brake 42 could alternatively be located on a side opposite sheave 46 from motor 40. Sheave 46 includes traction surfaces 50 for mechanically engaging ropes 16 (not shown in FIG. 2).

Drive shaft 44 is driven by motor 40, which causes sheave 46 to rotate. This causes linear movement of elevator car 12 and counterweight 14 due to friction between ropes 16 and traction surfaces 50. Motor 40 drives drive shaft 44 based on signals received from controller 24. The magnitude and direction of force (i.e., torque) provided by motor 40 on ropes 16 controls the speed and direction of elevator car 12, as well as the acceleration and deceleration of elevator car 12.

When elevator car 12 is stopped, brake 42 engages drive shaft 44 to prevent movement of elevator car 12. In one embodiment, brake 42 is a drum brake including a drum with two internal pads that are biased into engagement by heavy springs and are caused to disengage by electromagnetic force. When brake 42 is engaged, a torque is exerted on brake 42 that is caused by the relative weights of elevator car 12 and counterweight 14. In particular, if the overall mass of elevator car 12 (i.e., the mass of elevator car 12 plus the load therein) is greater than the mass of counterweight 14, a torque is exerted on brake 42 in one direction. Conversely, if the mass of counterweight 14 is greater than the overall mass of elevator car 12, a torque is exerted on brake 42 in the opposite direction. Because brake 42 is typically engaged only when elevator car 12 is stopped to secure elevator car 12 in place, the brake torque is not easily verifiable through normal use.

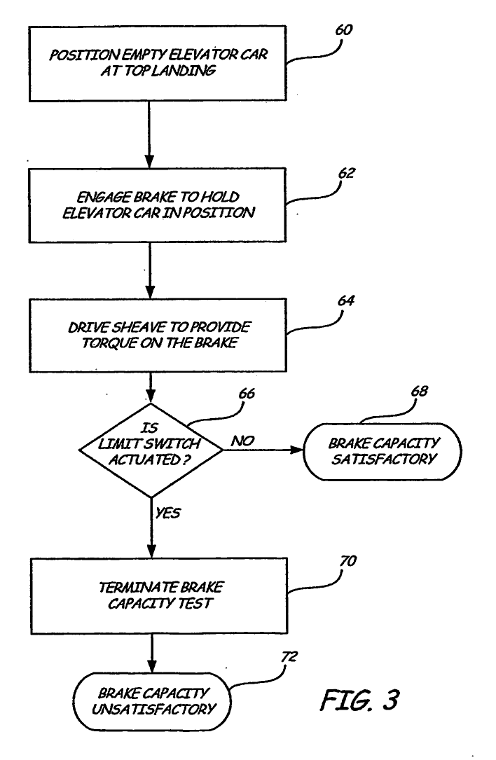

FIG. 3 is a flow diagram for a process of testing brake 42 according to the present invention. A loadless elevator car 12 is positioned at the top landing (i.e., landing L3) of hoistway HW (step 60). Elevator system 10 may include, for example, weight sensors to determine when there is no load on elevator car 12 prior to starting the test. By positioning elevator car 12 at the top landing, elevator car 12 is positioned adjacent to limit switch 23, which will be actuated by movement of elevator car 12.

When the elevator car 12 stops at landing L3, brake 42 is engaged on drive shaft 44 to prevent elevator car 12 from moving (step 62). The mass of counterweight 14 is greater than the mass of loadless elevator car 12, and thus counterweight 14 pulls downward on ropes 16 and exerts a torque on brake 42 due to friction between ropes 16 and fraction surfaces 50.

With brake 42 engaged on drive shaft 44, motor 40 drives sheave 46 and drive shaft 44 to provide an additional torque on brake 42 (step 64). The torque provided by motor 40 is such that the combination of the torque exerted by counterweight 14 and the torque exerted by motor 40 on brake 42 simulates a load condition in elevator car 12. Thus, the torque provided by motor 40 is in the same direction as the torque exerted by counterweight 14. In order to test the capacity of brake 42, the total torque provided on brake 42 simulates at least the maximum rated load for elevator car 12. In one embodiment, the total torque simulates at least 125% of the maximum rated load for elevator car 12. The amount of torque provided by motor 40 is based on code and standards requirements for the capacity of brake 42. Motor 40 drives sheave 46 and drive shaft 44 for a short period of time (e.g., less than a few seconds) to test brake 42.

While motor 40 drives sheave 46 and drive shaft 44 with brake 42 engaged, it is determined whether limit switch 23 is actuated by the cam on elevator car 12 (step 66). Alternatively, signals from position encoder 22 may be received and processed by controller 24 to determine whether elevator car 12 moves from landing L3, or a technician may visually determine if elevator car 12 moves. If elevator car 12 does not actuate limit switch 23 while motor 40 exerts a torque on brake 42, then the capacity of brake 42 is satisfactory (step 68). In other words, brake 42 is capable of holding a load in elevator car 12 equal to the load simulated by the torque exerted by motor 40 on brake 42.

On the other hand, if elevator car 12 actuates limit switch 23 while motor 40 exerts a torque on brake 42, brake 42 is incapable of holding a load in elevator car 12 equal to the load simulated by the torque exerted by motor 40 on brake 42. When limit switch 23 is actuated, a signal is sent to controller 24 to remove power to elevator hoist machine 20 and terminate the brake test (step 70). Actuation of limit switch 23 by elevator car 12 is indicative that the capacity of brake 42 is unsatisfactory (step 72). When the capacity of brake 42 is unsatisfactory, controller 24 disables elevator system 10 until brake 42 may be replaced.

In summary, the present invention is directed to testing a brake in an elevator system including a car and a counterweight connected to the car by a rope. The rope is actuated by a rotating member that is driven by a motor. The car is positioned at a reference position in the hoistway adjacent to a hoistway limit switch, and the brake is engaged to hold the car at the reference position. The rotating member is then driven to provide a testing force on the brake that simulates a load in the elevator car of at least a maximum rated load for the car. The brake test is terminated if the hoistway limit switch is actuated. If the hoistway limit switch is not actuated during the test, then the brake capacity is satisfactory. If the hoistway limit switch is actuated, then the brake capacity is insufficient, and the brake needs to be replaced. This brake testing is important in elevator systems in which the brake is used only to hold the elevator in a stopped position, since the brake may not otherwise show signs of wear until it fails. The testing can be performed periodically and automatically without requiring the presence of a technician.

Although the present invention has been described with reference to examples and preferred embodiments, workers skilled in the art will recognize that changes may be made in form and detail without departing from the spirit and scope of the invention.

1. A method for testing a brake in an elevator system including an elevator hoistway having a car and a counterweight connected to the car by a cable, the cable actuated by a rotating member driven by a motor, the method comprising:
positioning the elevator car at a reference position in the hoistway adjacent to a hoistway limit switch;
engaging the brake to hold the car at the reference position;
driving the rotating member to provide a testing force on the brake that simulates a load in the car of at least a maximum rated load for the car; and
terminating the brake testing if the car moves to actuate the hoistway limit switch.

2. The method of claim 1, wherein the positioning step comprises positioning the car with no load at the reference position.

3. The method of claim 1, wherein the engaging step comprises engaging the brake to prevent movement of the rotating member.

4. The method of claim 1, wherein the driving step comprises driving the rotating member such that a first force on the brake provided by relative weights of the counterweight and car and a second force provided by the motor equals the testing force.

5. The method of claim 1, wherein the testing force simulates a load of at least 125% of the maximum rated load for the car.

6. The method of claim 1, and further comprising:
sensing motion of the car relative to the reference position.

7. A system comprising:
an elevator including an elevator hoistway having an elevator car and a counterweight connected to the elevator car by a rope;
a machine including a motor, a rotating member driven by the motor for actuating the rope, and a brake for preventing the rotating member from rotating;
a controller operable to test the brake by driving the rotating member with the brake engaged to provide a testing torque on the brake that simulates a load in the elevator car of at least a maximum rated load for the elevator car, and
a hoistway limit switch that provides a signal to the controller to terminate the test if the elevator car moves to actuate the hoistway limit switch while the rotating member is being driven.

8. The system of claim 7, wherein the system further comprises an encoder for sensing motion of the elevator car when the testing torque is provided by driving the rotating member.

9. The system of claim 8, wherein the encoder provides a signal to the controller to terminate the test if motion of the elevator car is sensed.

10. The system of claim 7, wherein the testing torque simulates a load of at least 125% of the maximum rated load for the elevator car.

11. The system of claim 7, wherein the controller tests the brake when the elevator car is without a load.

12. The system of claim 7, wherein the elevator car is positioned at a top landing in the elevator hoistway to test the brake.

13. The system of claim 7, wherein relative weights of the elevator car and the counterweight provide at least a portion of the testing torque.

14. A method for testing a brake in an elevator system, the method comprising:
engaging the brake to hold the elevator in position, wherein relative weights of an elevator car and a counterweight in the elevator system produce a first torque on the brake when the brake is engaged;
driving an elevator motor when the brake is engaged to produce a second torque on the brake, wherein the first torque and the second torque simulate a load in the elevator car of at least a maximum rated load for the elevator car; and
terminating the brake testing if the elevator car actuates a hoistway limit switch.

15. The method of claim 14, wherein engaging the brake to hold the elevator in position comprises preventing relative movement between the elevator car and the counterweight.

16. The method of claim 14, wherein the first torque and the second torque simulate a load of at least 125% of the maximum rated load for the car.

17. The method of claim 14, wherein the brake is tested with no load in the elevator car.

18. The method of claim 14, wherein the sensing step comprises processing signals from an encoder related to movement of the elevator car.

19. The method of claim 14, wherein the elevator car is positioned at a top landing in an elevator hoistway to test the brake.

20. The method of claim 14, and further comprising:
sensing movement of the elevator car when driving the elevator motor with the brake engaged.
